(19) United States
(12) Patent Application Publication
(10) Pub. No.: US 2013/0137447 A1
(43) Pub. Date: May 30, 2013

(54) INTER-CELL INTERFERENCE COORDINATION METHOD AND DEVICE FOR CONTROL CHANNEL AND DATA CHANNEL

(71) Applicant: FUJITSU LIMITED, Kawasaki-shi (JP)

(72) Inventors: Yi ZHANG, Beijing (CN); Yuantao ZHANG, Beijing (CN); Hua ZHOU, Beijing (CN); Jianming WU, Beijing (CN)

(73) Assignee: FUJITSU LIMITED, Kawasaki-shi (JP)

(21) Appl. No.: 13/750,402

(22) Filed: Jan. 25, 2013

Related U.S. Application Data
(63) Continuation of application No. PCT/CN2010/075778, filed on Aug. 6, 2010.

(51) Int. Cl. H04W 72/08

(52) U.S. Cl. CPC H04W 72/082
USPC 455/452.1

(57) ABSTRACT

An inter-cell interference coordination for a control channel where a base station of a first cell receives information, that is needed during allocating control channel resources to each user of a second cell that needs interference coordination, from a base station of the second cell, determines the control channel resources which will be allocated to the users of the second cell that need interference coordination, allocates the control channel resources used by the users of the first cell, judges whether search spaces of the control channel resources that are allocated to the users of the first cell and second cell satisfy an orthogonal requirement, and if not, forbids the users of the first cell to use the control channel resources that are allocated to the users of the first cell.

### CROSS-REFERENCE TO RELATED APPLICATIONS

This application is based upon PCT Application No. PCT/CN2010/075778, filed on Aug. 6, 2010 and entitled “INTER-CELL INTERFERENCE COORDINATION METHOD AND DEVICE FOR CONTROL CHANNEL AND DATA CHANNEL.” The contents of which are wholly incorporated herein by reference.

### FIELD OF THE INVENTION

The present invention relates to transmission technologies in a wireless communication system, and in particular to an inter-cell interference coordination method and apparatus for control channel and data channel in a wireless communication system such as Long Term Evolution-Advanced (LTE-A).

### BACKGROUND OF THE INVENTION

Adopting the traditional homogeneous network structure, the 3rd Generation Partnership Project (3GPP) Long Term Evolution (LTE) system consists of hexagonal cellular systems. In order to further increase system capacity, a heterogeneous network structure has been introduced in the next-generation wireless communication system, LTE-A. LTE-A includes macro cells, femto cells, pico cells, remote radio heads (RRHs), relays, etc. By deploying the new wireless nodes, it can increase system capacity as well as provide better services to subscribers in particular locations and improve system performance. On the other hand, the newly-deployed nodes may cause interference to subscribers in originally-deployed cells, and even result in certain coverage holes. Therefore, it is desired to provide an enhanced inter-cell interference coordination method to further optimize system performance.

The LTE uses the Fractional Frequency Reuse (FFR) scheme, its principle is that all frequency resources can be scheduled by center subscribers, but the scheduling of some non-overlapping frequency resources is limited for edge subscribers in different cells. FIG. 1 is a schematic diagram illustrating the principle of FFR where the reuse factor is ⅓. The cells A, B, C, D, E, F and G can schedule center subscribers within the entire frequency set, however, the cell A can only schedule edge subscribers within frequency set f1; the cells B, D and F can only schedule edge subscribers within frequency set f2; and the cells C, E and G can only schedule edge subscribers within frequency set f3. By scheduling with limited frequency set, inter-cell interference to edge subscribers can be significantly lowered, while full frequency reuse is realized among cell-center subscribers, thereby increasing system capacity.

The deployment of LTE-A systems is relatively flexible, which may cause difficulties in the inter-cell interference coordination. Currently, it is agreed in the art that the following two scenarios need the interference coordination. As shown in FIG. 2, the first scenario is a scenario where macro cells and femto cells interfere with each other. A femto cell serves a subscribing subscriber group, and a macro cell serves all subscribers. When a subscriber served by a macro cell enters the service area of a femto cell, the subscriber can switch to the femto cell to be served by the femto cell base station if the subscriber belongs to the subscriber group subscribing to the femto cell. However, if the subscriber does not belong to the subscriber group subscribing to the femto cell, the subscriber will experience strong interference in the same transmission channel occupied by the femto cell, e.g., the interference to the downlink of macro cell A by the downlink of femto cell B and the interference to the uplink of femto cell C by the uplink of macro cell A. Therefore, the interference coordination is needed for the femto cells and the macro cell. As shown in FIG. 3, the second scenario is a scenario where macro cells and pico cells interfere with each other. A pico cell uses service range expansion techniques to increase system capacity. With service expansion techniques, edge subscribers served by a pico cell will experience larger interference from macro cell A, e.g., the interference to the downlink of pico cell B by the downlink of macro cell A and the interference to the uplink of macro cell A by the uplink of pico cell C. Therefore, the interference coordination is needed for the macro cell and the pico cells.

### SUMMARY OF THE INVENTION

A brief summary of the present invention is given below, to provide a basic understanding on some aspects of the present invention. It will be appreciated that the summary is not an exhaustive description of the present invention. It is not intended to define a key or important part of the present invention, nor is it intended to define the scope of the present invention. It aims to give some concepts in a simplified form, as a preface to the more detailed description described later.

A control channel has to ensure the reliability of transmission, and a data channel has to provide a higher transmission rate, which results in different design requirements for data transmission. Therefore, different designs are desired for different channels. The method of orthogonal resource partitioning can ensure the reliability of transmission, and can provide a better interference coordination result; and resource reuse can allow different cells use the same resource at the same time, and can provide a higher transmission rate. To meet design requirements of different channels, a good interference coordination method can provide a fine tradeoff between transmission reliability and transmission rate.

In view of current situation in the art and the above design requirement, an object of the present invention is to provide an inter-cell interference coordination method and apparatus for control channel and data channel in a wireless communication system such as LTE-A, which can solve one or more of the problems in the art.

In order to achieve the above object, according to an aspect of the present invention, it is provided an inter-cell interference coordination method for control channel in a wireless communication system, including: receiving, by a base station of a first cell, information needed to allocate control channel resources for each subscriber of a second cell requiring interference coordination, from a base station of the second cell; determining the control channel resources allocated to the subscriber of the second cell requiring interference coordination in frequency domain, by using the received information; allocating control channel resources used by a subscriber of the first cell; judging whether searching spaces of the control channel resources allocated to the subscriber of the first cell and the subscriber of the second cell satisfy orthogonality requirement; and prohibiting, if the orthogonality requirement is not satisfied, the subscriber of the first cell from using the control channel resources allocated thereto.

According to another aspect of the present invention, it is further provided an inter-cell interference coordination method for data channel in a wireless communication system, including: notifying, by a base station of a first cell, resources requiring interference coordination, to a base station of a second cell; receiving a precoding matrix indicator (PMI) used by each subscriber of the second cell on the resources requiring interference coordination, from the base station of the second cell; pairing a PMI used by each subscriber of the first cell requiring interference coordination with the received PMI used by the subscriber of the second cell; and allocating preferentially frequency resources in a frequency resource set exclusively occupied by the first cell to the subscriber of the first cell which can not be paired and requires interference coordination.

According to another aspect of the present invention, it is further provided an inter-cell interference coordination apparatus for control channel in a wireless communication system, which resides in a base station of a first cell, and includes: a reception unit adapted to receive information needed to allocate control channel resources for each subscriber of the second cell requiring interference coordination from a base station of the second cell; a determination unit adapted to determine the control channel resources allocated to the subscriber of the second cell requiring interference coordination in frequency domain using the received information; an allocation unit adapted to allocate control channel resources used by a subscriber of the first cell; a judgment unit adapted to judge whether searching spaces of the control channel resources allocated to the subscriber of the first cell and the subscriber of the second cell satisfy orthogonality requirement; and a prohibition unit adapted to prohibit, if the orthogonality requirement is not satisfied, the subscriber of the first cell from using the control channel resources allocated thereto.

According to another aspect of the present invention, it is further provided an inter-cell interference coordination apparatus for data channel in a wireless communication system, which resides in a base station of a first cell, and includes: a notification unit adapted to notify resources requiring interference coordination to a base station of a second cell; a reception unit adapted to receive a precoding matrix indicator (PMI) used by each subscriber of the second cell on the resources requiring interference coordination from the base station of the second cell; a pairing unit adapted to pair a PMI used by the subscriber of the first cell requiring interference coordination with the received PMI used by the subscriber of the second cell; and an interference coordination unit adapted to allocate preferentially frequency resources in a frequency resource set exclusively occupied by the first cell to the subscriber of the first cell which can not be paired and requires interference coordination.

According to another aspect of the present invention, it is further provided a wireless communication system, which includes at least one base station and at least one subscriber, and uses the inter-cell interference coordination method as described above.

According to another aspect of the present invention, it is further provided a computer program product which implements the above inter-cell interference coordination method for control channel and/or data channel.

According to another aspect of the present invention, it is further provided a computer-readable medium, where computer program code implementing the above inter-cell interference coordination method for control channel and/or data channel is recorded.

According to the above technical solutions of the present invention, for the control channel, joint resource allocation can be performed for the control channels of multiple cells, while ensuring the orthogonality of transmission resources for different cells in the frequency domain, thereby ensuring reliable transmission in the control channels and achieving a good interference coordination result; for the data channel, exclusive frequency resources can be preferentially allocated to subscribers that cannot be paired with the PMI, hence, when exclusive frequency resources are exhausted, space-domain PMI coordination can be performed for the interfered subscribers that can be paired with the PMI, thereby providing a high spectral efficiency and a good interference coordination result.

### BRIEF DESCRIPTION OF THE DRAWINGS

For a better understanding of the present invention, the present invention will be described in detail hereinafter with reference to the accompanying drawings. It is noted that in the accompanying drawings the same or like reference numerals denote the same or like components. The accompanying drawings, together with the detailed description below, are included in the specification and form a part of the specification, and are used to illustrate the preferred embodiments of the present invention and explain the principle and advantages of the present invention. In the accompanying drawings:

FIG. 1 is a schematic diagram illustrating the principle of FFR in an LTE system;

FIG. 2 illustrates a scenario where macro cells and femto cells interfere with each other;

FIG. 3 illustrates a scenario where macro cells and pico cells interfere with each other;

FIG. 4 is a flowchart of an inter-cell interference coordination method for control channel according to an embodiment of the present invention;

FIG. 5 is a schematic diagram illustrating an inter-cell interference coordination method for control channel according to an embodiment of the present invention;

FIG. 6 is a flowchart of an inter-cell interference coordination method for data channel according to an embodiment of the present invention;

FIG. 7 illustrates the signaling interactions of an inter-cell interference coordination for data channel according to an embodiment of the present invention;

FIG. 8 is a block diagram illustrating an inter-cell interference coordination apparatus for control channel according to an embodiment of the present invention;

FIG. 9 is a block diagram illustrating an inter-cell interference coordination apparatus for data channel according to an embodiment of the present invention; and

FIG. 10 is a block diagram of a subscriber of a first cell according to an embodiment of the present invention.

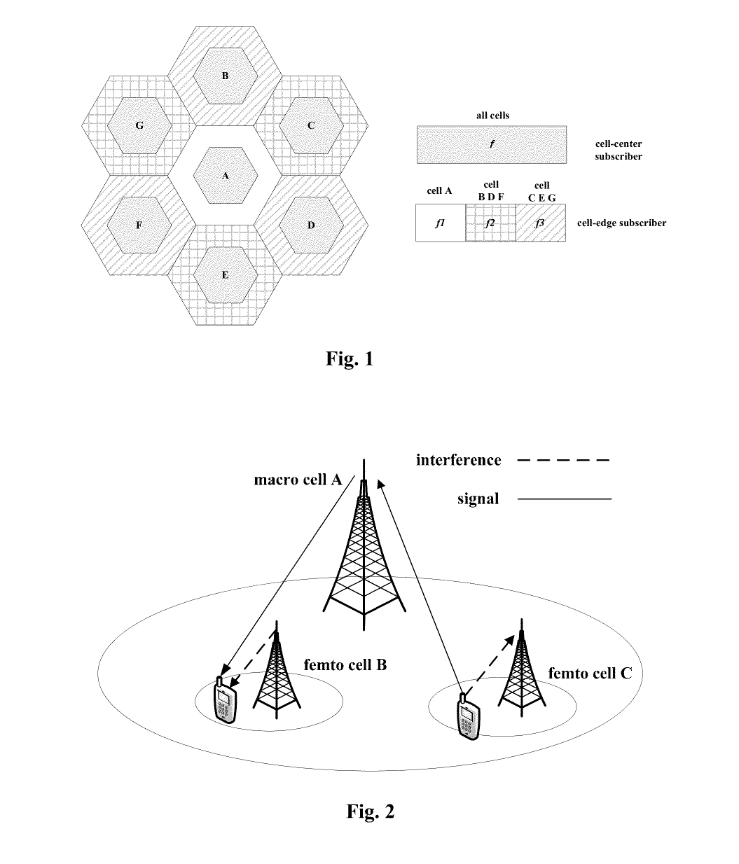

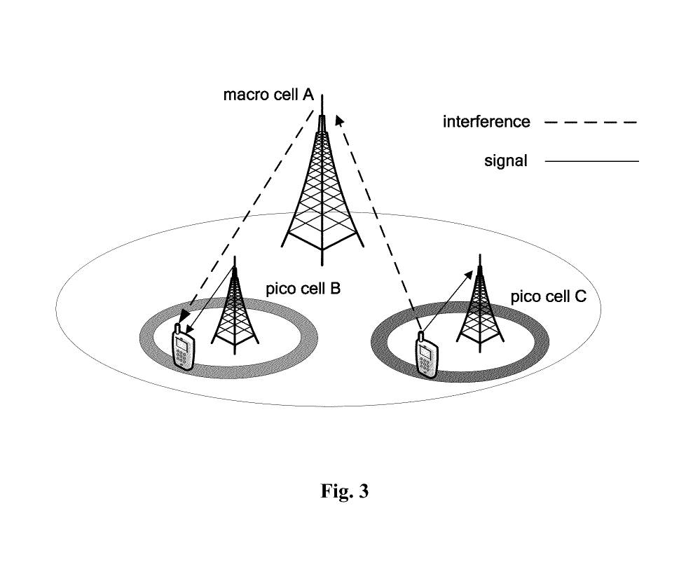

The skilled person will appreciate that elements in the figures are illustrated for simplicity and clarity, and are not necessarily drawn to scale. For example, the size of some of the elements in the accompanying drawings may be enlarged with respect to the other components, in order to facilitate improving the understanding of the embodiments of the present invention.

### DETAILED DESCRIPTION OF THE INVENTION

Exemplary embodiments of the present invention will be described hereinafter in conjunction with the accompanying drawings. In the interest of clarity and simplicity, not all the features of an actual implementation are described herein. However, it will be appreciated that in the development of any actual embodiment, numerous implementation-specific decisions shall be made in order to achieve the developer's specific goals, such as compliance with system-related and business-related constraints, which may vary from one implementation to another. Moreover, it will be appreciated that such development effort might be complex and time-consuming, but would nevertheless be a routine undertaking for those skilled in the art having the benefit of the present disclosure.

In addition, it is noted that only those apparatus structures and/or processing steps that are closely related to the technical solutions of the present invention are shown in the figures in order to avoid unnecessarily obscuring the present invention. Other details that are not closely related to the present invention are omitted.

The inter-cell interference coordination method and apparatus for control channel and/or data channel in a wireless communication system according to the embodiments of the present invention will be described hereinafter in detail with reference to the figures. An LTE-A system and a macro cell plus pico cell deployment will be used as an example, however, it would be appreciated by those skilled in the art that the present invention is not limited thereto. For instance, the present invention is also applicable to a macro cell plus femto cell deployment. In addition, the present invention may be applied to wireless communication systems such as Wimax.

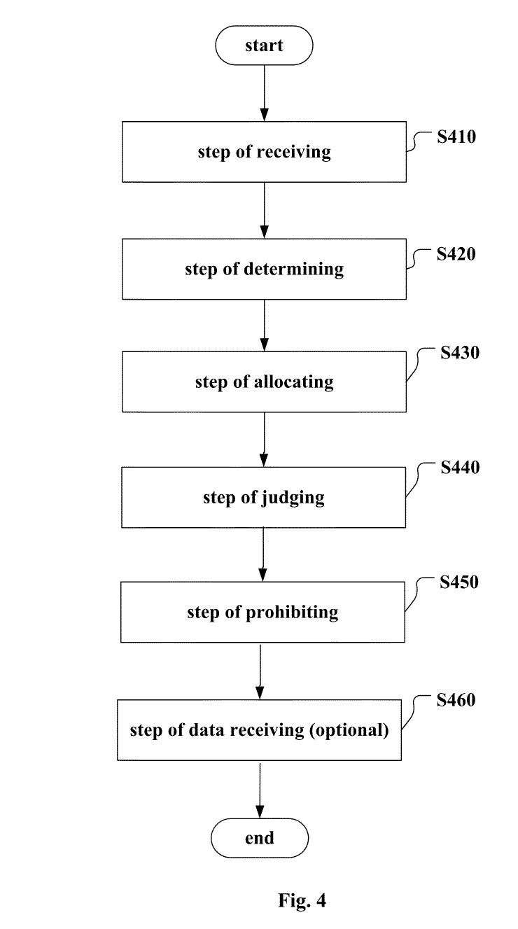

FIG. 4 is a flowchart of an inter-cell interference coordination method for control channel according to an embodiment of the present invention. Here, as an example, the first cell and the second cell may be a macro cell and a pico cell, respectively. It is noted that those skilled in the art will appreciate that the present invention is not limited thereto. For instance, the first cell may be a femto cell and the second cell may be a macro cell.

Firstly, in step S410, a macro cell base station receives information needed to allocate control channel resources for each subscriber of the pico cell requiring interference coordination. As an example, the information may include the number of Control Channel Elements (CCEs), Radio Network Temporary Identification (RNTI) and number of the transmission subframe used by each subscriber of the pico cell requiring interference coordination.

Next, in step S420, the macro cell base station determines the control channel resources allocated to the subscriber of the pico cell requiring interference coordination in frequency domain by using the received information, e.g., according to 3GPP-Release 8.

Next, in step S430, the macro cell base station allocates control channel resources used by a subscriber of the macro cell itself.

Next, in step S440, the macro cell base station judges whether searching spaces of the control channel resources allocated to the subscriber of the macro cell and the subscriber of the pico cell satisfy orthogonality requirement. As an example, the orthogonality requirement may be measured with the proportion of the control channel resources of the macro cell overlapped with the pico cell to the whole control channel resources needed to be occupied by the pico cell. For instance, the threshold for the overlapping proportion may be set as 10%, and the orthogonality requirement is considered satisfied if the overlapping proportion is below 10%.

Finally, in step S450, if the orthogonality requirement is not satisfied, the subscriber of the macro cell is prohibited from using the control channel resources allocated thereto, so that interference with the subscriber of the pico cell is prevented.

Preferably, if the orthogonality requirement is not satisfied, a parameter for control channel resource allocation of the subscriber of the pico cell, e.g., the aggregation level of control channel, may be adjusted, so as to change the control channel resources allocated to the subscriber of the pico cell to satisfy the orthogonality requirement. In this case, the macro cell needs to notify the pico cell base station of a result of the control channel resource allocation for the subscriber of the pico cell, so that the pico cell base station can perform control channel resource allocation for the subscriber of the pico cell requiring interference coordination according to the result of the control channel resource allocation. Preferably, the notified result of control channel resource allocation may include only a starting position of the control channel resources in the searching space, and the aggregation level of control channel.

Optionally, the inter-cell interference coordination method for control channel according to an embodiment of the present invention may further include step S460, in which the subscriber of the macro cell receives data by using the allocated control channel resources.

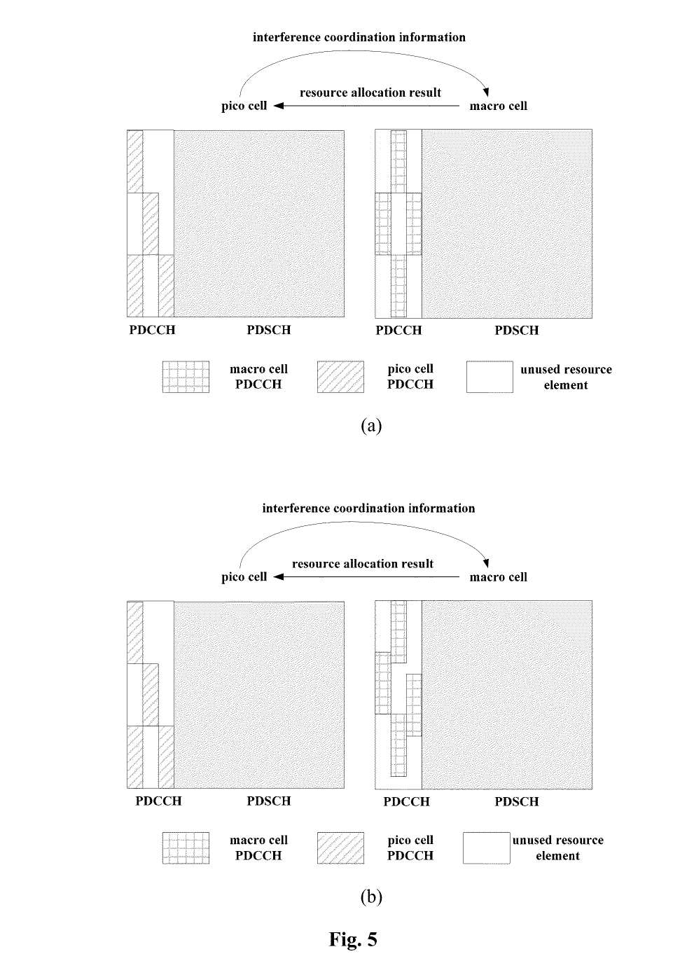

FIG. 5 is a schematic diagram illustrating an inter-cell interference coordination method for control channel according to an embodiment of the present invention. Specifically, FIG. 5(a) illustrates a resource allocation scheme where the control channels are orthogonal in the frequency domain, wherein the orthogonality represents the orthogonality of search spaces during the decoding of the control channels; and FIG. 5(b) illustrates a resource allocation scheme where the control channels are partially orthogonal in the frequency domain, wherein the partial orthogonality means that search spaces of the control channels are certainly overlapping in the frequency domain, however, the overlapping portion is controlled within a range allowed by decoding, e.g., 90% orthogonality).

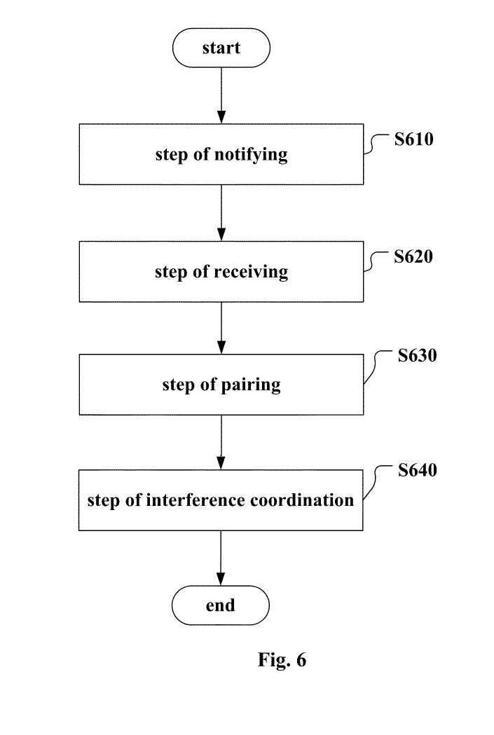

FIG. 6 is a flowchart of an inter-cell interference coordination method for data channel according to an embodiment of the present invention. Here, as an example, the first cell and the second cell may be a pico cell and a macro cell, respectively. It is noted that those skilled in the art will appreciate that the present invention is not limited thereto. For instance, the first cell may be a macro cell and the second cell may be a femto cell.

Firstly, in step S610, a pico cell base station notifies a macro cell base station of resources requiring interference coordination.

Next, in step S620, the pico cell base station receives from the macrocell base station a PMI used by a subscriber of the macro cell on the resources requiring interference coordination. The macro cell base station can obtain this information by the subscriber of the macro cell reporting its PMI for pairing.

Next, in step S630, a PMI used by the subscriber of the pico cell requiring interference coordination is paired with the received PMI used by the subscriber of the macro cell. The pico cell base station can obtain this information by the subscriber of the pico cell reporting its PMI for pairing.

Next, in step S640, according to the result of paring in the step S630, interference coordination is performed for the subscriber of the pico cell requiring interference coordination. Specifically, frequency resources in a frequency resource set exclusively occupied by the pico cell are allocated preferentially to the subscriber of the pico cell that cannot be paired and requires interference coordination. Here, the frequency resource set exclusively occupied by the pico cell is configurable, e.g., can be configured by a gateway server through a higher layer.

In addition, in step S640, preferably, if the frequency resources in the exclusive frequency resource set are not exhausted, the frequency resources in the exclusive frequency resource set continues to be allocated to the subscriber of the pico cell that can be paired and requires interference coordination. Furthermore, preferably, for the subscriber of the pico cell to which the frequency resources in the exclusive frequency resource set are not allocated and which can be paired, interference coordination is performed in a manner of space domain PMI coordination.

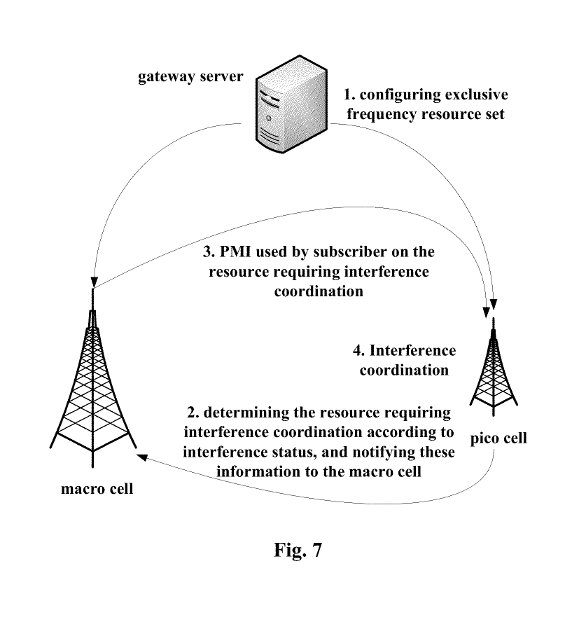

FIG. 7 illustrates the signaling interaction procedure of inter-cell interference coordination for data channel according to an embodiment of the present invention. Firstly, e.g., a gateway server configures an exclusive frequency resource set for the pico cell through a higher layer. Then, the pico cell determines resources requiring interference coordination according to interference status and notifies this information to the macro cell. Then, the macro cell notifies the pico cell of the PIM information used by the subscriber on the resources requiring interference coordination. Finally, the pico cell performs interference coordination schema for two-dimensional resource allocation. The interaction information between the macro cell and the pico cell may be transmitted through the interface such as X2 or S1 or the air interface, etc.

Although the inter-cell interference coordination method for control channel and/or data channel according to the embodiments of the present invention are described above with reference to the figures, the skilled in the art shall understood that the flowcharts shown in FIG. 4 and FIG. 6 are merely exemplary, and those skilled in the art can modify the methods shown in FIG. 4 and FIG. 6 according to the different practice applications and specific requirements. For example, if necessary, the executing order of some of the steps in the methods shown in FIG. 4 and FIG. 6 may be adjusted. Alternatively, some processing steps may be omitted or added.

The inter-cell interference coordination apparatus for control channel and/or data channel according to the embodiments of the present invention will be described hereinafter in detail with reference to the figures.

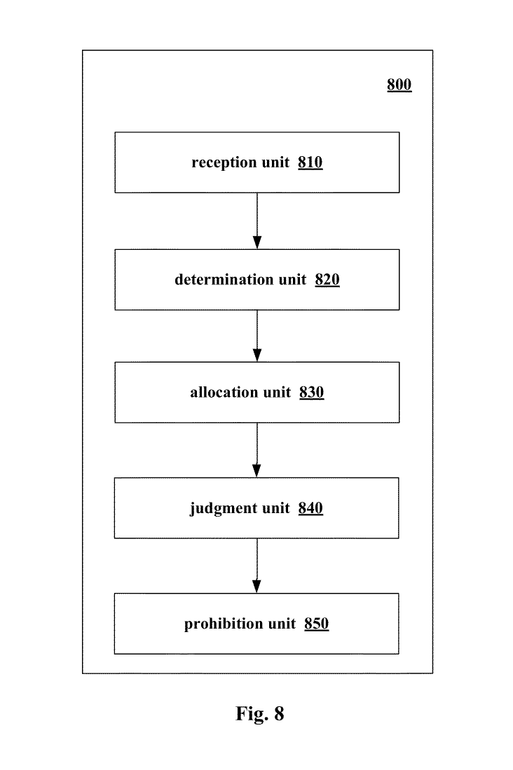

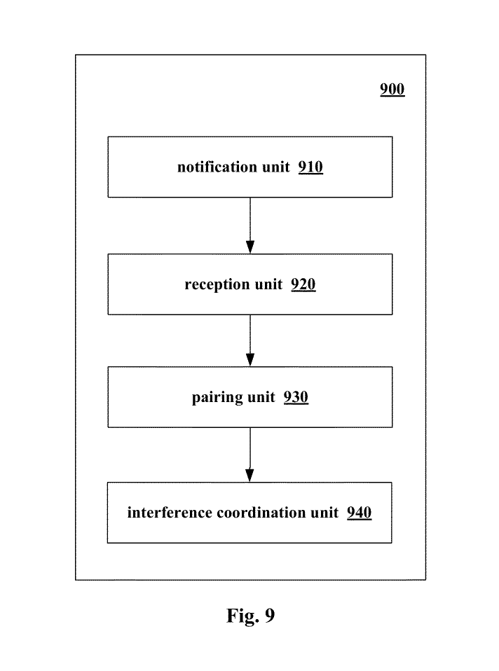

FIG. 8 is a block diagram illustrating an inter-cell interference coordination apparatus 800 for control channel according to an embodiment of the present invention. For simplicity reasons, only the components that are closely related to the present invention are shown in the figure. The inter-cell interference coordination apparatus 800 can implement the inter-cell interference coordination method for control channel as described above with FIG. 4.

As shown in FIG. 8, the inter-cell interference coordination apparatus 800 may resides in a base station of a first cell, and may include a reception unit 810, a determination unit 820, an allocation unit 830, a judgment unit 840 and a prohibition unit 850.

Specifically, the reception unit 810 is adapted to receive information needed to allocate control channel resources for each subscriber of the second cell requiring interference coordination from a base station of the second cell. The determination unit 820 is adapted to determine the control channel resources allocated to the subscriber of the second cell requiring interference coordination in frequency domain using the received information. The allocation unit 830 is adapted to allocate control channel resources used by a subscriber of the first cell. The judgment unit 840 may be adapted to judge whether searching spaces of the control channel resources allocated to the subscriber of the first cell and the subscriber of the second cell satisfy orthogonality requirement. The prohibition unit 850 may be adapted to prohibit, if the orthogonality requirement is not satisfied, the subscriber of the first cell from using the control channel resources allocated thereto.

The specific and/or optional processing process of each component in the inter-cell interference coordination apparatus 800 can be referred to the flowchart of the method described above. Accordingly, detailed description of the specific operations and processing processes of the components is omitted here for simplicity reasons.

It is noted that the structure of the inter-cell interference coordination apparatus 800 shown in FIG. 8 is merely exemplary, and those skilled in the art can modify the block diagram shown in FIG. 8 if necessary.

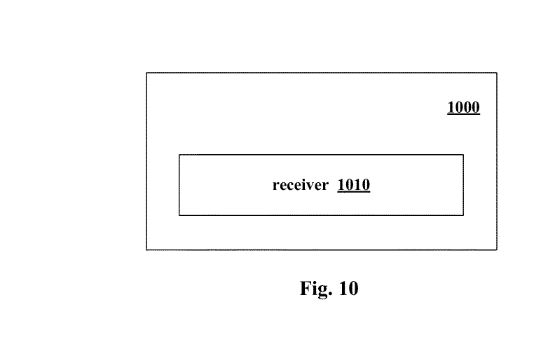

FIG. 9 is a block diagram illustrating an inter-cell interference coordination apparatus 900 for data channel according to an embodiment of the present invention. For simplicity reasons, only the components that are closely related to the present invention are shown in the figure. The inter-cell interference coordination apparatus 900 can implement the inter-cell interference coordination method for data channel as described above with FIG. 6.

As shown in FIG. 9, the inter-cell interference coordination apparatus 900 may reside in a base station of a first cell, and may include a notification unit 910, a reception unit 920, a paring unit 930 and an interference coordination unit 940.

Specifically, the notification unit 910 may be adapted to notify resources requiring interference coordination to a base station of a second cell. The reception unit 920 may be adapted to receive a PMI used by the subscriber of the second cell on the resources requiring interference coordination from the base station of the second cell. The pairing unit 930 may be adapted to pair a PMI used by the subscriber of the first cell requiring interference coordination with the received PMI used by the subscriber of the second cell. The interference coordination unit 940 may be adapted to allocate preferentially frequency resources in a frequency resource set exclusively occupied by the first cell to the subscriber of the first cell which can not be paired and requires interference coordination.

Preferably, if the frequency resources in the frequency resource set are not exhausted, the interference coordination unit 940 may continue to allocate the frequency resources in the frequency resource set to the subscriber of the first cell which can be paired and requires interference coordination.

Furthermore, preferably, for the subscriber of the first cell to which the frequency resources in the frequency resource set are not allocated and which can be paired, the interference coordination unit 940 may performs interference coordination in a manner of space domain PMI coordination.

The specific and/or optional processing process of each component in the inter-cell interference coordination apparatus 900 can be referred to the flowchart of the method described above. Accordingly, detailed description of the specific operations and processing processes of the components is omitted here for simplicity reasons.

It is noted that the structure of the inter-cell interference coordination apparatus 900 shown in FIG. 9 is merely exemplary, and those skilled in the art can modify the block diagram shown in FIG. 9 if necessary.

According to an embodiment of the present invention, it is further provided a wireless communication system, which includes at least one base station and at least one subscriber (it can be also referred as a user terminal). The wireless communication system can use the inter-cell interference coordination method as described above with reference to FIG. 4 and/or FIG. 6.

According to an embodiment of the present invention, it is further provided a wireless communication system, which includes at least one base station and at least one subscriber (it can be also referred as a user terminal). The wireless communication system can include the inter-cell interference coordination apparatus as described above with reference to FIG. 8 and/or FIG. 9.

FIG. 10 is a block diagram of a subscriber 1000 of a first cell according to an embodiment of the present invention. As shown in FIG. 10, the subscriber 1000 of the first cell may include a receiver 1010 configured to receive data by using the allocated control channel resources.

Clearly, each of the operations of the methods of the present invention can be implemented with a computer-executable program stored in any machine-readable storage medium.

Moreover, the object of the present invention can be implemented by: providing a storage medium with the computer-executable program code directly or indirectly to a system or device, and reading and executing the program code by a computer or CPU in the system or device. In this case, provided that the system or device is capable of executing programs, the implementation of the present invention is not limited to programs. Moreover, the program can be in any form, e.g., a target program, an interpreter-executed program or a script provided to an operating system.

The machine-readable storage medium includes, but is not limited to: various storage and storage units, semiconductor apparatuses, and disk units such as optical discs, magnetic disks and magneto-optical disks, as well as any other medium suitable for information storage.

Moreover, the present invention can also be implemented by a computer downloading computer program code of the present invention from a website connected to the Internet, installing the program and executing it.

In the devices and methods of the present invention, clearly, the components or steps can be decomposed and/or recombined. The decomposition and/or recombination shall be considered equivalent to the present invention. Moreover, the steps carrying the series of processing can be executed in the chronological order as described, but not necessarily. Some of the steps can be performed in parallel or independently from one another.

Although the embodiments of the present invention is described in details above with reference to the accompanying drawings, it should be understood that the embodiments described herein are for illustrative purposes only and shall not be interpreted as limiting the scope of the invention. Various modifications and alternations can be made by those skilled in the art without deviation from the spirit and scope of the present invention. Therefore, the scope of the present invention shall be defined by the appended claims and their equivalents.

1. An inter-cell interference coordination method for control channel in a wireless communication system, comprising:
receiving, by a base station of a first cell, information needed to allocate control channel resources for each subscriber of a second cell requiring interference coordination, from a base station of the second cell;
determining the control channel resources allocated to the subscriber of the second cell requiring interference coordination in frequency domain, by using the received information;
allocating control channel resources used by a subscriber of the first cell;
judging whether searching spaces of the control channel resources allocated to the subscriber of the first cell and the subscriber of the second cell satisfy orthogonality requirement; and
prohibiting, if the orthogonality requirement is not satisfied, the subscriber of the first cell from using the control channel resources allocated thereto.

2. The inter-cell interference coordination method according to claim 1, wherein the information needed to allocate the control channel resources for each subscriber of the second cell requiring interference coordination comprises: the number of control channel elements, a radio network temporary identifier (RNTI) and a transmission sub-frame number used by each subscriber of the second cell requiring interference coordination.

3. The inter-cell interference coordination method according to claim 1, wherein the orthogonality requirement is measured with a proportion of the control channel resources of the second cell overlapped with the first cell to the whole control channel resources needed to be occupied by the second cell.

4. The inter-cell interference coordination method according to claim 1, further comprising:
adjusting, if the orthogonality requirement is not satisfied, an aggregation level of control channel for the control channel resource allocation of the subscriber of the second cell, so as to change the control channel resources allocated to the subscriber of the second cell to satisfy the orthogonality requirement; and
notifying a result of the control channel resource allocation for the subscriber of the second cell requiring interference coordination to the base station of the second cell.

5. The inter-cell interference coordination method according to claim 4, wherein the result of control channel resource allocation only comprises a start position of the control channel resources in the searching space thereof, and the aggregation level of control channel.

6. The inter-cell interference coordination method according to claim 1, wherein the wireless communication system is an Long Term Evolution-Advanced (LTE-A) system, the first cell is a macro cell and the second cell is a pico cell, or the first cell is a femto cell and the second cell is a macro cell.

7. An inter-cell interference coordination method for data channel in a wireless communication system, comprising:
notifying, by a base station of a first cell, resources requiring interference coordination, to a base station of a second cell;
receiving a precoding matrix indicator (PMI) used by each subscriber of the second cell on the resources requiring interference coordination, from the base station of the second cell;
pairing a PMI used by each subscriber of the first cell requiring interference coordination with the received PMI used by the subscriber of the second cell; and
allocating preferentially frequency resources in a frequency resource set exclusively occupied by the first cell, to the subscriber of the first cell which can not be paired and requires interference coordination.

8. The inter-cell interference coordination method according to claim 7, further comprising:
if the frequency resources in the frequency resource set are not exhausted, continuing to allocate the frequency resources in the frequency resource set to the subscriber of the first cell which can be paired and requires interference coordination.

9. The inter-cell interference coordination method according to claim 7, further comprising:
performing, for the subscriber of the first cell to which the frequency resources in the frequency resource set are not allocated and which can be paired, interference coordination in a manner of space domain PMI coordination.

10. The inter-cell interference coordination method according to claim 7, wherein the wireless communication system is a Long Term Evolution-Advanced (LTE-A) system, the first cell is a pico cell and the second cell is a macro cell, or the first cell is a macro cell and the second cell is a femto cell.

11. An inter-cell interference coordination apparatus for control channel in a wireless communication system, which resides in a base station of a first cell, and comprises:
a reception unit adapted to receive information needed to allocate control channel resources for each subscriber of the second cell requiring interference coordination from a base station of the second cell;
a determination unit adapted to determine the control channel resources allocated to the subscriber of the second cell requiring interference coordination in frequency domain using the received information;
an allocation unit adapted to allocate control channel resources used by a subscriber of the first cell;
a judgment unit adapted to judge whether searching spaces of the control channel resources allocated to the subscriber of the first cell and the subscriber of the second cell satisfy orthogonality requirement; and
a prohibition unit adapted to prohibit, if the orthogonality requirement is not satisfied, the subscriber of the first cell from using the control channel resources allocated thereto.

12. The inter-cell interference coordination apparatus according to claim 11, wherein the information needed to allocate the control channel resources for each subscriber of the second cell requiring interference coordination comprises: the number of control channel elements, a radio network temporary identifier (RNTI) and a transmission sub-frame number used by each subscriber of the second cell requiring interference coordination.

13. The inter-cell interference coordination apparatus according to claim 11, wherein the orthogonality requirement is measured with a proportion of the control channel resources of the second cell overlapped with the first cell to the whole control channel resources needed to be occupied by the second cell.

14. The inter-cell interference coordination apparatus according to claim 11, further comprising:
an adjustment unit adapted to adjust, if the orthogonality requirement is not satisfied, an aggregation level of control channel for the control channel resource allocation of the subscriber of the second cell, so as to change the control channel resources allocated to the subscriber of the second cell to satisfy the orthogonality requirement; and
a notification unit adapted to notify a result of the control channel resource allocation for the subscriber of the second cell requiring interference coordination to the base station of the second cell.

15. The inter-cell interference coordination apparatus according to claim 14, wherein the result of control channel resource allocation only comprises a start position of the control channel resources in the searching space thereof, and the aggregation level of control channel.

16. The inter-cell interference coordination apparatus according to claim 11, wherein the wireless communication system is a Long Term Evolution-Advanced (LTE-A) system, the first cell is a macro cell and the second cell is a pico cell, or the first cell is a femto cell and the second cell is a macro cell.

17. An inter-cell interference coordination apparatus for data channel in a wireless communication system, which resides in a base station of a first cell, and comprises:
a notification unit adapted to notify resources requiring interference coordination to a base station of a second cell;
a reception unit adapted to receive a precoding matrix indicator (PMI) used by each subscriber of the second cell on the resources requiring interference coordination from the base station of the second cell;
a pairing unit adapted to pair a PMI used by the subscriber of the first cell requiring interference coordination with the received PMI used by the subscriber of the second cell; and
an interference coordination unit adapted to allocate preferentially frequency resources in a frequency resource set exclusively occupied by the first cell, to the subscriber of the first cell which can not be paired and requires interference coordination.

18. The inter-cell interference coordination apparatus according to claim 17, wherein if the frequency resources in the frequency resource set are not exhausted, the interference coordination unit continues to allocate the frequency resources in the frequency resource set to the subscriber of the first cell which can be paired and requires interference coordination.

19. The inter-cell interference coordination apparatus according to claim 17, wherein for the subscriber of the first cell to which the frequency resources in the frequency resource set are not allocated and which can be paired, the interference coordination unit performs interference coordination in a manner of space domain PMI coordination.

20. The inter-cell interference coordination apparatus according to claim 17, wherein the wireless communication system is a Long Term Evolution-Advanced (LTE-A) system, the first cell is a pico cell and the second cell is a macro cell, or the first cell is a macro cell and the second cell is a femto cell.
